(19) United States
(12) Patent Application Publication
(10) Pub. No.: US 2015/0169214 A1
(43) Pub. Date: Jun. 18, 2015

(54) GRAPHICAL INPUT-FRIENDLY FUNCTION SELECTION

(71) Applicant: Lenovo (Singapore) Pte. Ltd., Singapore (SG)

(72) Inventors: Scott Edwards Kelso, Cary, NC (US); Howard Locker, Cary, NC (US); Karen Ruth Kluttz, Raleigh, NC (US); Geoffrey Simon Bula, Apex, NC (US)

(73) Assignee: Lenovo (Singapore) Pte. Ltd., Singapore (SG)

(21) Appl. No.: 14/132,063

(22) Filed: Dec. 18, 2013

(51) Int. Cl. G06F 3/0488

(52) U.S. Cl. CPC G06F 3/04883

(57) ABSTRACT

An embodiment provides a method, including: ascertaining, via an input component of an information handling device, a graphical input; determining, using a processor, two or more functions associated with the graphical input; and providing, using the processor, an indication co-displayed with a rendering of the graphical input and associated with the two or more functions. Other aspects are described and claimed.

### BACKGROUND

Information handling devices (“devices”), for example laptop computers, tablets, smart phones, e-readers, etc., may be used to accept user inputs in various formats. Among the formats of user inputs currently utilized are graphical inputs, such as gesture inputs, handwriting inputs, image inputs, e.g., a gesture input by a user via a pen/stylus. Graphical inputs may be directly sensed (e.g., via touching a touch sensitive surface such as a touch screen) and/or indirectly sensed (e.g., via a camera or optical sensor or other sensing component that detects an object proximate to a touch sensitive surface, tracks an object's movement in three-dimensional (3D) space, etc.).

A user, for example, may employ a pen to provide various graphical inputs (e.g., command inputs, handwriting inputs, etc.). A common context for employing pen input is in a touch screen interface on a mobile information handling device such as a smart phone or a tablet computer, although many other contexts may be encountered.

### BRIEF SUMMARY

In summary, one aspect provides a method, comprising: ascertaining, via an input component of an information handling device, a graphical input; determining, using a processor, two or more functions associated with the graphical input; and providing, using the processor, an indication co-displayed with a rendering of the graphical input and associated with the two or more functions.

Another aspect provides an information handling device, comprising: an input component; a display; a processor; and a memory that stores instructions executable the processor to: ascertain, via the input component, a graphical input; determine two or more functions associated with the graphical input; and provide an indication co-displayed with a rendering of the graphical input and associated with the two or more functions.

A further aspect provides a program product, comprising: a storage medium comprising computer readable program code, the computer readable program code comprising: code that ascertains, via an input component of an information handling device, a graphical input; code that determines, using a processor, two or more functions associated with the graphical input; and code that provides, using the processor, an indication co-displayed with a rendering of the graphical input and associated with the two or more functions.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example method of providing graphical input-friendly function selection.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Graphical inputs, such as gesture inputs, handwriting inputs, image inputs, e.g., a gesture input by a user via a pen/stylus, are increasingly common. As a non-limiting example of a graphical input, a pen input, e.g., to a touch sensitive surface such as a touch screen, may have a functionality associated with it over and above simply rendering the pen input as a drawing, handwriting, or machine text. For example, a particular gesture, e.g., drawing a predetermined symbol, may be associated with a predetermined function, e.g., labeling a message as high priority, forming a note, etc. There are, however, only a limited number of easy to perform or intuitive gestures that a user can accomplish, e.g., using a pen. The limited number does not cover the total number of actions or functions that are needed within graphical input user experience. Thus, in the example context of pen input, the same pen gesture is reused for committing different actions.

Accordingly, an embodiment provides a graphical input-friendly function selection used when the same graphical input has two or more different functions associated with it. For example, an embodiment ascertains pen input, e.g., a pen gesture input, and thereafter determines if two or more functions are associated therewith. If so, an embodiment may present an indication thereof to allow the user an opportunity to disambiguate the conflicting functionality assigned to the pen gesture.

The illustrated example embodiments will be best understood by reference to the figures. The following description is intended only by way of example, and simply illustrates certain example embodiments.

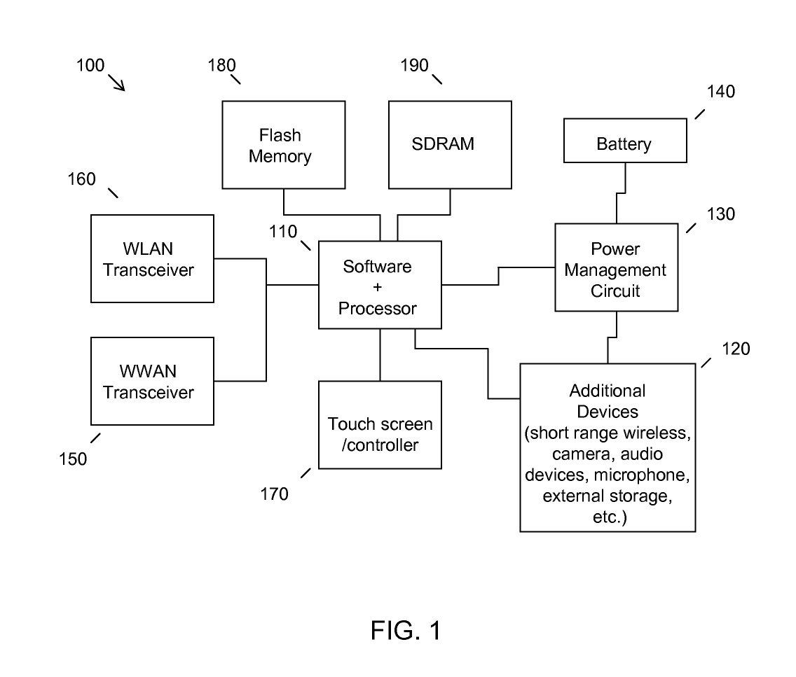

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a short range wireless communication device, such as a BLUETOOTH radio. Commonly, system 100 will include a touch screen 170 for data input and display, e.g., for accepting pen gesture inputs. System 100 also typically includes various memory devices, for example flash memory 180 and SDRAM 190.

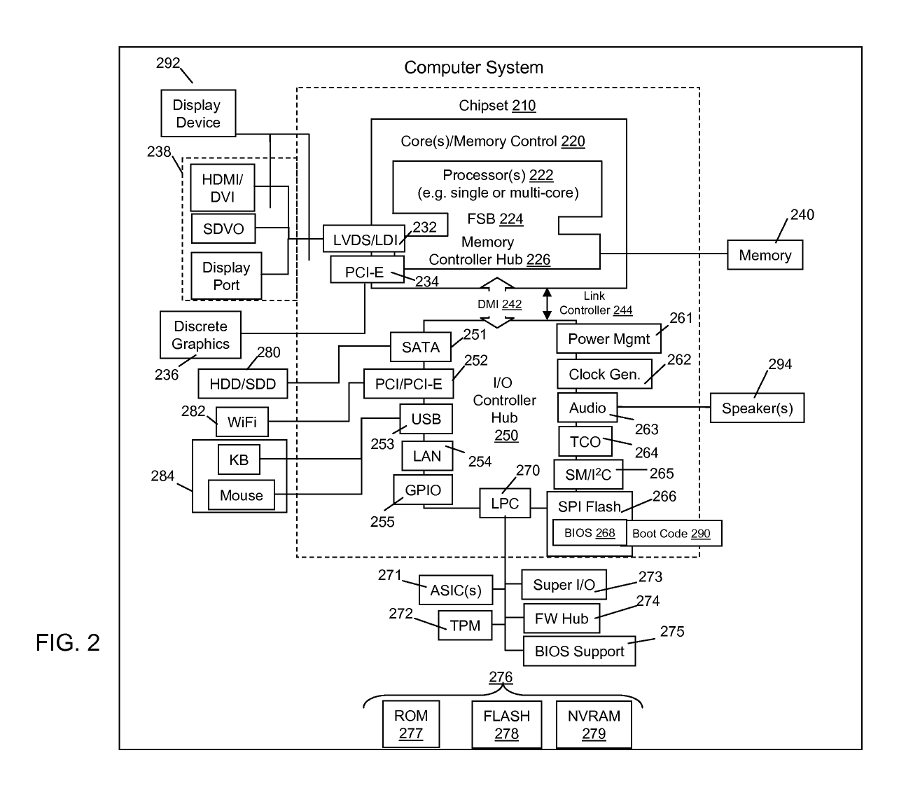

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280 et cetera), a PCI-E interface 252 (for example, for wireless connections 282), a USB interface 253 (for example, for devices 284 such as a digitizer, keyboard, mice, cameras, phones, microphones, storage, other connected devices, et cetera), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may used in devices that operate using graphical inputs such as pen gesture inputs. Pen gesture inputs are used throughout as a non-limiting example; however, other graphical inputs, e.g., hand gestures performed by a user, image inputs loaded and scanned for symbols, etc., may also be used according to the principles taught herein.

As an example, by drawing a square symbol with a pen, one function associated with this gesture may be creating a note, as described in more detail in co-pending and commonly assigned U.S. patent application Ser. No. 13/965,861, entitled “SYSTEM-WIDE HANDWRITTEN NOTES”, filed on Aug. 13, 2013, the contents of which are incorporated by reference herein. However, another function associated with this pen input may be inserting a pre-selected object (e.g., a video, a picture, etc.) within the area, e.g., of a touch-screen display bounded by the rendered pen input square.

Thus, there may be two (or more) functions that are different but nonetheless associated with the same pen gesture. An embodiment provides a graphical input-friendly (in this example, a pen-friendly) method of indicating to the user that there are multiple possible functions and allowing the user to select which function to use.

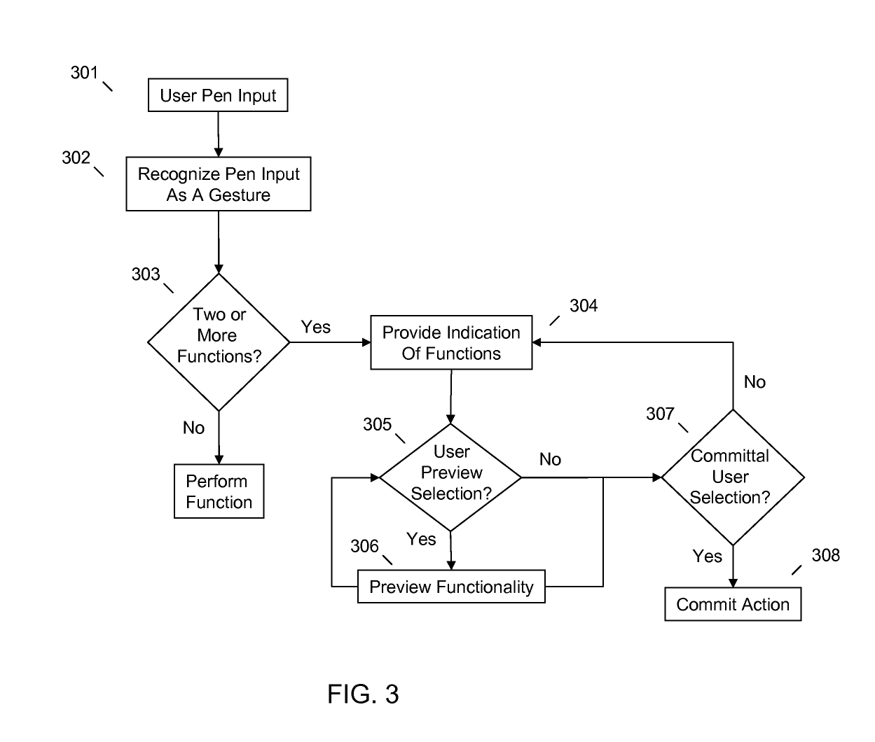

Referring to FIG. 3, when a user provides pen input to a pen input component, e.g., a touch screen display, a digitizer, etc., at 301, in an embodiment, a pen input engine recognizes the pen gesture at 302. That is, the pen input gesture engine analyzes the pen input to match it to a predetermined gesture input (e.g., letter, symbol, drawing, etc.).

With a gesture input ascertained/identified, an embodiment determines if there are two or more functions assigned to the gesture at 303. If an embodiment determines that a gesture that has two or more functions associated with it, it provides to the user an indication of the functions that may be executed or actions that may be committed at 304. Otherwise, if a single function is associated with the pen input, an embodiment may proceed to commit the action associated therewith.

With respect to the indication provided, by way of example, an embodiment may create a shape around the gesture with different tabs at 304. Each tab is large enough that the user can interact with it as an interface component, e.g., select the tab with the pen. As each tab is selected by the user, e.g., hovers over a tab with a pen, as determined at 305, the function of that tab may be performed or previewed at 306 so that the user can see what functions are defined by this gesture. In an embodiment, this process may comprise a training or learning process, wherein the changes resulting from committing an action via tab selection are temporary such that the user may cycle through the various tabs, e.g., repeating steps 305-306. The changes may be presented visually, e.g., as a gray-out, or any other indicator indicating it is temporary performance of the action or functionality may be provided.

When the user decides which function is correct or currently desired, the user can provide further or committal input at 307 to commit to a particular action at 308, e.g., by lifting the pen off the screen and, e.g., after a predetermined delay, the temporary function becomes permanent with a change in the visual indicator letting the user know this. Other committal inputs may be utilized, e.g., affirmative selection of a tab which the user is hovering over, e.g., tapping a tab to commit the selection, etc.

In an embodiment, in lieu of or after a learning process has been performed, an embodiment may take a user's first selection as a committal selection, e.g., foregoing the previews. In other words, in an embodiment, steps 305-306 may be omitted.

In an embodiment, the order of the tabs along the outlined around the gesture may be organized, e.g., based on a past history of a specific user, based on the patterns of use learned from a group, e.g., a group of associated cloud users, and/or a context, e.g., what application the user is providing pen input to. In this way, an embodiment may place the most likely function in the first or highest priority tab and less likely functions in remaining tabs. This permits an embodiment to learn the preferences of a user and/or a group of users and organize the indication of the various functions appropriately.

Additionally or in the alternative, an embodiment may utilize a process similar to that outlined in FIG. 3 to recognize a gesture in the first place. That is, in an embodiment, a graphical input such as a pen input may not conveniently map to a particular, predetermined gesture at 302. As such, an embodiment may provide previews of candidate gestures at 302 of FIG. 3 such that a user may confirm the particular gesture input. Thereafter, the method may progress similar to that of FIG. 3, e.g., according to a gesture being thus recognized.

As may be appreciated from the foregoing, an embodiment provides a graphical input-friendly function selection to disambiguate or resolve situations where multiple functions or actions are associated with the same input. Thus, a user drawing a note gesture with a pen may be provided with tabs for selecting a function, e.g., forming a system wide note versus copying content bounded by the note gesture from an underlying application. The indications may be organized and reorganized, e.g., based on past selections of user(s).

As will be further appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
ascertaining, via an input component of an information handling device, a graphical input;
determining, using a processor, two or more functions associated with the graphical input; and
providing, using the processor, an indication co-displayed with a rendering of the graphical input and associated with the two or more functions.

2. The method of claim 1, wherein the indication comprises interactive user interface components.

3. The method of claim 2, wherein the interactive user interface components are rendered as ordered tabs in a display of the information handling device.

4. The method of claim 3, wherein the graphical input is pen input; and
further comprising:
rendering pen input in the display;
wherein the ordered tabs are rendered in association with the rendered pen input.

5. The method of claim 3, wherein the ordered tabs are ordered according to a user profile.

6. The method of claim 5, wherein the user profile is based on data selected from the group consisting of user-specific data and group data.

7. The method of claim 2, further comprising receiving, via an interactive user interface component, a user selection.

8. The method of claim 7, further comprising displaying a temporary indication of an action to be committed according to the user selection.

9. The method of claim 7, further comprising committing an action according to the user selection.

10. The method of claim 9, further comprising updating the indication of functions based on user input.

11. An information handling device, comprising:
an input component;
a display;
a processor; and
a memory that stores instructions executable the processor to:
ascertain, via the input component, a graphical input;
determine two or more functions associated with the graphical input; and
provide an indication co-displayed with a rendering of the graphical input and associated with the two or more functions.

12. The information handling device of claim 11, wherein the indication comprises interactive user interface components.

13. The information handling device of claim 12, wherein the interactive user interface components are rendered as ordered tabs in a display of the information handling device.

14. The information handling device of claim 13, wherein the graphical input is pen input; and
wherein the instructions are further executable by the processor to:
render pen input in the display;
wherein the ordered tabs are rendered in association with the rendered pen input.

15. The information handling device of claim 13, wherein the ordered tabs are ordered according to a user profile.

16. The information handling device of claim 15, wherein the user profile is based on data selected from the group consisting of user-specific data and group data.

17. The information handling device of claim 12, wherein the instructions are further executable by the processor to receive, via an interactive user interface component, a user selection.

18. The information handling device of claim 17, wherein the instructions are further executable by the processor to display a temporary indication of an action to be committed according to the user selection.

19. The information handling device of claim 17, wherein the instructions are further executable by the processor to commit an action according to the user selection.

20. A program product, comprising:
a storage medium comprising computer readable program code, the computer readable program code comprising:
code that ascertains, via an input component of an information handling device, a graphical input;
code that determines, using a processor, two or more functions associated with the graphical input; and
code that provides, using the processor, an indication co-displayed with a rendering of the graphical input and associated with the two or more functions.
